(19) United States
(12) Patent Application Publication
(10) Pub. No.: US 2026/0330156 A1
(43) Pub. Date: Oct. 22, 2026

(54) System and Method for Generating Content Translations

(71) Applicant: The Toronto-Dominion Bank, Toronto (CA)

(72) Inventors: Ronald Allan KIELSTRA, Beamsville (CA); Anil Stewart BAKHLE, Guelph (CA); Mya Ella CERTOSSI, Kitchener (CA)

(73) Assignee: The Toronto-Dominion Bank, Toronto, ON (CA)

(21) Appl. No.: 19/182,205

(22) Filed: Apr. 17, 2025

(51) Int. Cl. G06F 40/58

(52) U.S. Cl. CPC G06F 40/58

(57) ABSTRACT

Computing system, method and devices for generating content translations. The method includes obtaining an input comprising content, ranking a plurality of translation models (e.g., including a large language model) based on the content, and presenting a first translation of the content based on a selected one of the plurality of translation models according to a corresponding ranking. The method also includes receiving a request to obtain a new translation of the content, using the selected one or a new one of the plurality of translation models to generate a second translation of the content, and presenting the second translation of the content to enable the translated content to be accepted or a further request for a new translation to be initiated.

### TECHNICAL FIELD

The following relates generally to translating content and, more particularly, to generating multiple content translations according to the content and available translation models to provide multiple options for the translation.

### BACKGROUND

Increasingly, more and more content is being provided virtually, to parties who are not the intended audience, or parties that do not have the capability to understand the content as intended. For example, enterprises may provide content with one intended audience in mind, and subsequently another audience with a different set of experience and/or knowhow can be guided to said content.

Machine translating of content adds additional challenges. The machine translation can add unnecessary complexity to the original content, or strip out necessary nuance in the translation, or generally be a poor translation.

Improved machine generated translations of content is desirable. Challenges can lead to misunderstandings, reduced user confidence, and potential errors when consuming content, e.g., when communicating with an enterprise regarding an application or service.

### BRIEF DESCRIPTION OF THE DRAWINGS

Embodiments will now be described with reference to the appended drawings wherein:

FIG. 1 is a schematic diagram of an example computing environment.

FIG. 2 illustrates a process workflow executed by a translation engine in the computing environment.

FIG. 3 provides a sequence diagram illustrating an example of a process workflow that may be executed using the configuration shown in FIG. 2.

FIGS. 4a and 4b are user interfaces providing a content translation tool in a messaging application.

FIG. 5 is a user interface illustrating an example of a content translation tool.

FIG. 6 is a block diagram of an example configuration for the translation engine.

FIG. 7 is a block diagram of an example configuration for an enterprise system.

FIG. 8 is a block diagram of an example configuration of a client device.

FIG. 9 is a flow chart illustrating example operations that may be performed in generating content translations.

FIG. 10 is a flow chart illustrating example operations that may be performed in enabling selection of a re-try option to present another content translation.

FIG. 11 is a flow chart illustrating example operations that may be performed in asynchronously generating multiple translation options and caching same for a re-try option.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

There are many new translation models emerging, which have been demonstrated and utilized in recent years. The best performing models are found to be ones that use the transformer machine learning (ML) architecture such as Google's T5 model. Large GPT models (also known as large language models (LLMs)) such as OpenAI's GPT4, are large decoder-only transformers that may not have been explicitly trained for translation tasks but have shown state-of-the-art results for translation in some cases. In addition, ML models can be used to transcribe voice to text, such as OpenAI's Whisper model, whose results can be piped to a text translation model. Some LLMs like GPT4o are multi-modal and can take voice as an input and perform translation in one step.

It is recognized that there can be advantages but challenges in the use of one of these translation models for the purpose of building a live translation tool to facilitate interactions between client users and enterprises, e.g., during interactions on an application. Using multiple translation models has been considered, as the accuracy of the translation can vary greatly from model to model, depending on the content and nature of the conversation.

The system described herein can utilize multiple ML or other translation models to provide alternative translations of conversational statements from a source language to a target language and then suggest a perceived best option for the translation to the client user (e.g., customer). The system can use customer behaviour to identify which models translate specific source texts most successfully. The system may apply this knowledge to proactively select the model most relevant to the conversation being translated, such that the user's translation experience becomes more efficient. The system may also extend this to cover additional source and output language combinations. The system may be configured to match the best model with the right content and thus different models may be considered the “best” option in any given session (e.g., on a conversation-by-conversation basis).

The system can be configured to implement a two-step process which may utilize ML to identify a proposed best translation model for a given portion of text (e.g., based on a current conversation) and then provide the user with an option to view alternate translations and select their preferred one. Users may be able to review a translation by looking at the back-translated text.

When the user inputs text, the presumed best translation model is run, and the back-translated text can be presented to the user for review. While the user is looking at the presumed best translation, one or more additional translation models can be run in the background to pre-emptively generate alternative translations and cache those in case a “re-try” occurs. The user may therefore be provided with the ability to then able to re-record or re-type their message, edit the existing message, or tell the machine to ‘re-try-the translation based on the original content in the input.

Selecting the ‘re-try’ option can result in the translation from the presumed “next best” translation model being displayed. Users are then able to choose which of the two translations is preferred and accept that translation option for their output, e.g., to send it to their conversation participant. By analyzing the conversation contents and tracking which translation model was ultimately selected, the system may be able to match input text/speech to the preferred translation model. This information can be used to optimize the translation experience over the long term.

To select best translation model, the system may train the ML model to identify and rank translation models in terms of degree of confidence that it is the best model for a given conversation. The following data points may be kept for each interaction:
Vector embedding of the content to be translated. The embedding may be generated by passing it through a lightweight embedding model (e.g., BERT);
Translation model used for the translation that was ultimately selected and sent by the user;
Text of the translation selected by the user. The text of the input and of the output can be considered together and processed to infer the more general topic of the conversation;
Source language;
Output language; and
User type, e.g., customer, colleague, etc.

The system can thus provide a user with the ability to access multiple ones (e.g., all) available translation models at once. Instead of presenting the user with a series of choices with respect to model type, accuracy rating, etc., which may be confusing to non-technical users, the system allows the user to access translations performed using the other models via a ‘re-try’ option. By doing so, users are not forced to come up with their own prompts or make a series of selections prior to translation, which can make the experience more efficient.

In an example workflow, the user inputs content having a certain language, either via text or speech. In the background, an ML model can be used to rank the available translation models in terms of likeliness to be selected by the user. The presumed best translation model for the conversation may then be used to translate text. The user can be presented with the backtranslation of the presumed best translation. While the user is looking at the presumed best translation, additional translation models can be run and cached in the background, in order from ‘most likely’ to ‘least likely’. If the user is unhappy with the translation, they are able to re-record or re-enter their message, edit the text transcript of the existing message, or tell the machine to “re-try” the translation. Upon re-try, the result from the presumed next mostly likely translation model can be displayed. This may continue down through the list of available translation models until they have all been displayed or one has been accepted. The user is able to either confirm that the “new” translation is better, and send it to their conversation partner, go back to the previous translation, tell the machine to “re-try” the translation again. These steps can repeat as necessary, until the user has selected a satisfactory translation for their use, to send to a conversation recipient, or for any other use.

According to one aspect, a computing system for adapting content translations is provided. The computing system includes a processor, and a memory coupled to the processor. The memory stores computer executable instructions that when executed by the processor cause the computing system to obtain an input comprising content, rank a plurality of translation models based on the content, present a first translation of the content based on a selected one of the plurality of translation models according to a corresponding ranking, receive a request to obtain a new translation of the content, use the selected one or a new one of the plurality of translation models to generate a second translation of the content, and present the second translation of the content to enable the second translation of the content to be accepted or a further request for a new translation to be initiated.

In certain example embodiments, the request causes the same content to be translated using the new one of the plurality of translation models.

In certain example embodiments, the request comprises a revised version of the content and causes the revised version of the content to be translated using the selected one of the plurality of translation models.

In certain example embodiments, the request comprises a revised version of the content and causes the revised version of the content to be translated using the new one of the plurality of translation models.

In certain example embodiments, the system is further configured to, after or while the first translation is being generated, translate the content using one or more of the plurality of translation models to prepare at least one re-try option.

In certain example embodiments, the system is further configured to receive a further request to obtain another new translation of the content, use the selected one, the new one, or another new one of the plurality of translation models to generate a third translation of the content; and present the third translation of the content to enable the translated content to be accepted or a further request for a new translation to be initiated.

In certain example embodiments, a translation selection model and the content are used to rank the plurality of translation models.

In certain example embodiments, the translation selection model is continuously trained based at least on the request to obtain the new translated content.

In certain example embodiments, at least one of the plurality of translation models comprises an LLM.

In certain example embodiments, at least one of the plurality of translation models comprises a third party translation model.

In certain example embodiments, the input comprises the content entered in a conversational messaging exchange.

In certain example embodiments, the input comprises the content entered in a translation tool.

In certain example embodiments, the computing system is coupled to a client application on a client device.

In certain example embodiments, the computing system is coupled to a server application on a server device, the server application providing translation functionality for a client application on a client device.

In another aspect, there is provided a method for generating content translations. The method is implemented by a computing system and includes obtaining an input comprising content, ranking a plurality of translation models based on the content, presenting a first translation of the content based on a selected one of the plurality of translation models according to a corresponding ranking, receiving a request to obtain a new translation of the content, using the selected one or a new one of the plurality of translation models to generate a second translation of the content, and presenting the second translation of the content to enable the second translation of the content to be accepted or a further request for a new translation to be initiated.

In certain example embodiments, the request causes the same content to be translated using the new one of the plurality of translation models.

In certain example embodiments, the request comprises a revised version of the content and causes the revised version of the content to be translated using the selected one of the plurality of translation models.

In certain example embodiments, the request comprises a revised version of the content and causes the revised version of the content to be translated using the new one of the plurality of translation models.

In certain example embodiments, the method may further include after or while the first translation is being generated, translating the content using one or more of the plurality of translation models to prepare at least one re-try option.

In another aspect, there is provided a computer readable medium storing computer-executable instructions for generating content translations, comprising computer-executable instructions that, when executed by a computing system, cause the computing system to obtain an input comprising content, rank a plurality of translation models based on the content, present a first translation of the content based on a selected one of the plurality of translation models according to a corresponding ranking, receive a request to obtain a new translation of the content, use the selected one or a new one of the plurality of translation models to generate a second translation of the content, and present the second translation of the content to enable the second translation of the content to be accepted or a further request for a new translation to be initiated.

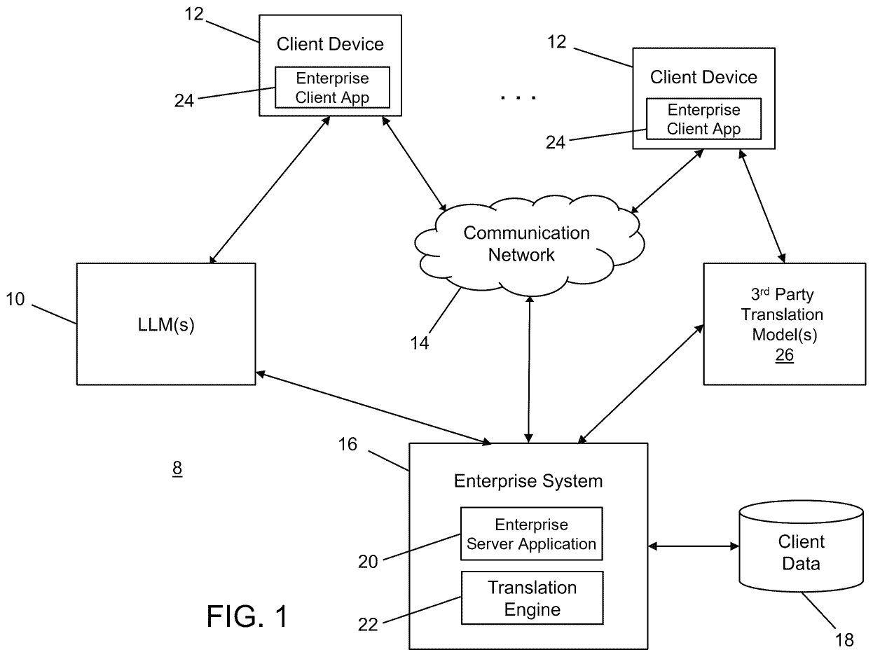

Referring now to the figures, FIG. 1 illustrates an example of a computing environment 8. In one aspect, the computing environment 8 may include one or more client devices 12, and one or more communications networks 14 connecting the components of the computing environment 8. The client devices 12 may include or otherwise have access to an LLM 10 and/or one or more third party translation models 26, via the communication network 14.

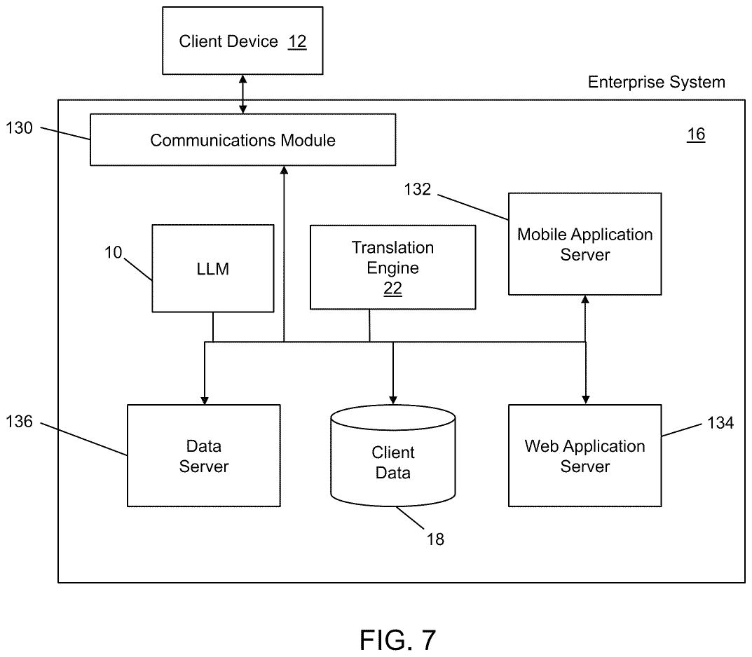

The computing environment 8 may also include an enterprise system 16 (e.g., a financial institution such as commercial bank and/or insurance provider) that provides financial services accounts to users and processes financial transactions associated with those financial service accounts. The enterprise system 16 may also include or have access to the LLM 10 and/or the third party translation model(s) 26. While several details of the enterprise system 16 have been omitted for clarity of illustration, reference will be made to FIG. 7 below for additional details. The enterprise system 16 includes, at least in part, an enterprise server application 20, which may be referred to as the server application 20 herein for brevity. The enterprise server application 20 may include or, as shown in FIG. 1, have access to, a translation engine 22. The translation engine 22 enables the enterprise server application 20 to obtain and provide multiple different translations of input content (e.g., translated content), for a UI provided by the enterprise client app 24, as described more fully below.

The enterprise system 16 also includes or otherwise has access to a datastore for storing client data 18. The enterprise system 16 may include other datastores not shown in FIG. 1. The data associated with a user can include client profile data that may be mapped to corresponding data for that user. The corresponding data may include any data associated with a domain. The domain, as noted above, may be associated with any particular service or utility being provided by the enterprise system 16 and need not be limited to any particular examples herein. For example, a financial institution may have an enterprise system 16 whose client data 18 includes financial data. It can be appreciated that such financial data could also include transaction data and/or the client data 18 shown in FIG. 1 and these datastores are described separately for illustrative purposes. The client data 18 can include both data that is associated with a client as well as data that is associated with one or more user accounts for that client as recognized by the computing environment 8.

The data associated with a client may include, without limitation, demographic data (e.g., age, gender, income, location, etc.), preference data input by the client, and inferred data generated through machine learning, modeling, pattern matching, or other automated techniques. The client data 18 may also include historical interactions and transactions associated with the enterprise system 16, e.g., login history, search history, communication logs, documents, etc.

Client devices 12 may be associated with one or more users. Users may be referred to herein as customers, clients, policy holders, correspondents, or other entities that interact with the enterprise system 16 and/or LLM 10 and/or third party model(s) 26 (directly or indirectly). The computing environment 8 may include multiple client devices 12, each client device 12 being associated with a separate user or associated with one or more users. In certain embodiments, a user may operate client device 12 such that client device 12 performs one or more processes consistent with the disclosed embodiments. In the example shown in FIG. 1, the client device includes an enterprise client application (app) 24, which may also be referred to herein as a client app 24 for brevity.

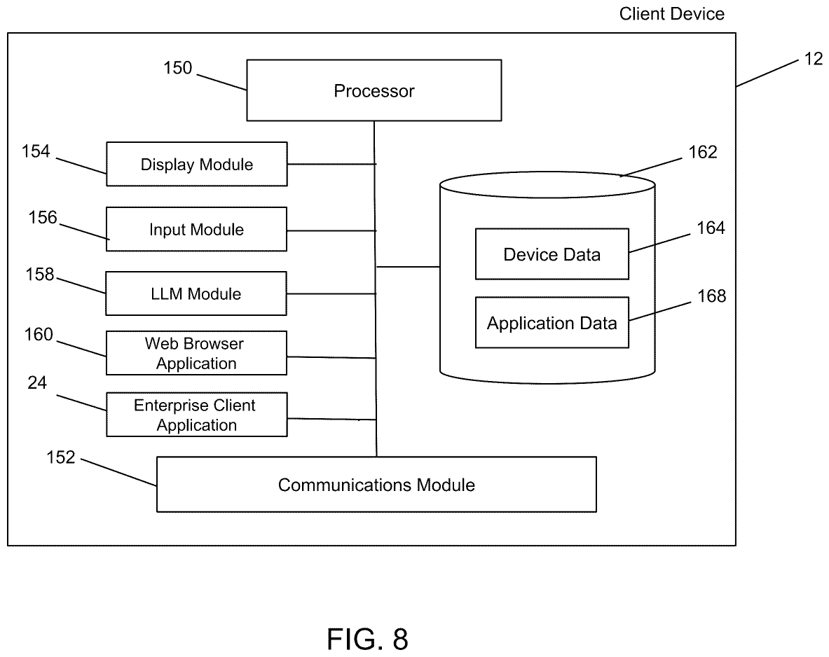

For example, the user may use client device 12 to engage and interface with a mobile or web-based financial (banking) application which uses or incorporates subsystems of the enterprise system 16, discussed further below. The client devices 12 in this example show a client app 24 but may also include a browser application 160 (see FIG. 8) for accessing web-based applications. The client app 24 may be or include a translation tool that utilizes the translation engine 22 to translate content for various purposes. While the translation engine 22 is shown as being part of the enterprise system 16, i.e., on the “server side” of the application, the translation engine 22 may instead be located at the client device 12 or separately from both the client device 12 and the enterprise system 16 (i.e., could be a separate stand-alone and centrally located service). As such, the configuration shown in FIG. 1 is illustrative.

The client devices 12 can access information within the enterprise system 16 and/or from the LLM 10, third party translation model(s) 26, or another remote computing environment associated with the enterprise system 16 in a variety of ways. For example, the client device 12 can access the enterprise system 16 via a web-based application, or a dedicated application such as the client app 24, which corresponds to the enterprise server application 20. Access can require the provisioning of different types of credentials (e.g., login credentials, two factor authentication, etc.). In example embodiments, each different device 12 can be provided with a unique degree of access, or variations thereof. For example, the client device 12 can be provided with a greater degree of access to the enterprise system 16 compared to other devices.

In certain aspects, client device 12 can include, but is not limited to, a personal computer, a laptop computer, a tablet computer, a notebook computer, a hand-held computer, a personal digital assistant, a portable navigation device, a mobile phone, a wearable device, a gaming device, an embedded device, a smart phone, a virtual reality device, an augmented reality device, third party portals, an automated teller machine (ATM), and any additional or alternate computing device, and may be operable to transmit and receive data across communication network 14.

Communication network 14 may include a telephone network, cellular, and/or data communication network to connect different types of client devices 12. For example, the communication network 14 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The enterprise system 16 can be understood to encompass the whole of the enterprise, a subset of a wider enterprise system (not shown), such as a system serving a subsidiary, or a system for a particular branch or team of the enterprise (e.g., a resource migration division of the enterprise). In at least one example embodiment, the enterprise system 16 is a financial institution system (e.g., a commercial bank) that provides financial services accounts to users and processes financial transactions associated with those financial service accounts. Such a financial institution system may provide to its customers various browser-based and mobile applications, e.g., for mobile banking, mobile investing, mortgage management, etc. Financial institutions can generate vast amounts of data, and have vast amounts of existing records, both of which can be migrated into digital and remote computing environments.

The enterprise system 16 may include both on-premises and remote computing assets provided by a remote computing environment-not shown (hereinafter referred to in the alternative as computing resources). The remote computing environment includes resources used by, or available, to the enterprise system 16 that are stored or managed by a party other than operator of the enterprise system 16. For example, the computing resources can include cloud-based storage services (e.g., database(s)). In at least some example embodiments, the computing resources include one or more tools developed or hosted by the external party, or tools for interacting with the computing resources. In at least one contemplated embodiment, the tool (referred to in the singular for ease of reference) is a tool for managing data lakes, and more specifically a tool for scheduling writing to a data lake associated with the Microsoft™ Azure™ data storage and processing platform. Further particularizing the example, the tool can allow a client device 12 to access the computing resources, and to thereafter configure an ingestion procedure wherein different data files are assigned to different processors (e.g., hardware) within the computing resources based on a configuration file. The tool can be or include aspects of a machine learning tool, or a tool associated with the Delta Lake Storage (ALDS)™ suite, etc. The computing resources can also include hardware resources, such as access to processing capability of server devices (e.g., cloud computing), and so forth.

The LLM 10 is shown as a separate entity in FIG. 1 for illustrative purposes and, in other configurations, may be part of or otherwise integrated into/with the enterprise system 16 (e.g., see FIG. 7). As shown in FIG. 1, the LLM 10 may be coupled to or in communication with the enterprise server application 20, via the enterprise system 16, to permit a user of a client device 12 to obtain a response related to a translation request that is submitted via the enterprise client app 24 and directed through the enterprise server application 20 in one example.

Referring again to FIG. 1, the enterprise system 16 may also include a cryptographic server (not shown) for performing cryptographic operations and providing cryptographic services (e.g., authentication (via digital signatures), data protection (via encryption), etc.) to provide a secure interaction channel and interaction session, etc. Such a cryptographic server can also be configured to communicate and operate with a cryptographic infrastructure, such as a public key infrastructure (PKI), certificate authority (CA), certificate revocation service, signing authority, key server, etc. The cryptographic server and cryptographic infrastructure can be used to protect the various data communications described herein, to secure communication channels therefor, authenticate parties, manage digital certificates for such parties, manage keys (e.g., public and private keys in a PKI), and perform other cryptographic operations that are required or desired for particular applications of the enterprise system 16. The cryptographic server may be used to protect the financial data and/or client data 18 by way of encryption for data protection, digital signatures or message digests for data integrity, and by using digital certificates to authenticate the identity of the users and client devices 12, with which the enterprise system 16 communicates to inhibit data breaches by adversaries. It can be appreciated that various cryptographic mechanisms and protocols can be chosen and implemented to suit the constraints and requirements of the particular deployment of the enterprise system 16 as is known in the art.

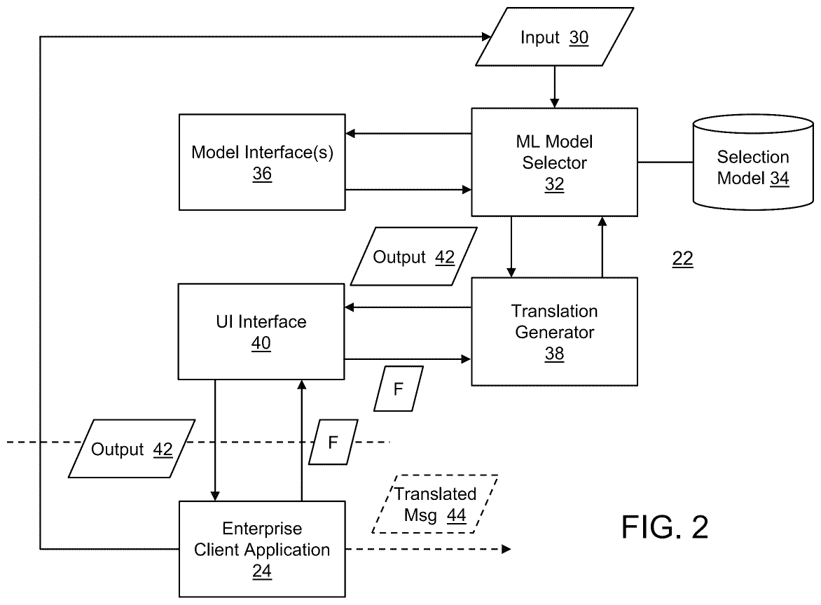

Turning now to FIG. 2, one example of a configuration for the system or computing environment 8 is shown. In this configuration, translation engine 22 is communicably and/or logically coupled to the enterprise client app 24 and the principles associated herewith may apply to client-side or server-side operations as they relate to either or both the enterprise client app 24 and the translation engine 22. For example, the translation engine 22 may be utilized directly by the client app 24 without involving the server application 20 and, in other examples, such as in a web browser-based client app 24, or where the computing power is to be offloaded from the client devices 12, be hosted by the enterprise system 16 along with the server application 20 (e.g., as illustrated in FIG. 7). As such, the components shown in FIG. 2 may be physically arranged in various configurations to suit the particular application and any example provided herein should not be considered limiting.

The translation engine 22 receives, obtains or is provided an input 30, which is this example originates from the enterprise client application 24. For example, the client application 24 may include a messenger or chat function or a stand-along translation tool, either of which may accept text, voice, or other inputs that can be interpreted in one language, for translation to another language. The input 30 is processed by an ML model selector 32. The ML model selector may employ ML or other artificial intelligence techniques to select a model from a collection or set of models. The ML model selector 32 may include or have access to a selection model 34, which has been trained to enable the ML model selector 32 to choose an appropriate model given the content of the input 30. For example, the ML model selector 32 may analyze the content of the input 30 to extract keywords, phrases, etc. and use those along with the selection model 34 to infer the best model from among available models. The ML model selector 32 may utilize vector embedding of the content to be translated to select the “best” translation. The embedding may be generated by passing it through a lightweight embedding model (e.g., BERT). The ML model selector 32 may also use the translation model used for the translation that was ultimately selected and sent by the user, and/or text of the translation selected by the user. The text of the input and of the output can be considered together and processed to infer the more general topic of the conversation. Other information that may be used includes, without limitation, source language, output language, and a user type, e.g., customer, colleague, etc.

The available models may vary in availability and suitability. In general, as shown in FIG. 2, the ML model selector 32 may utilize one or more model interfaces 36 to access either or both locally and remotely stored language models, e.g., by communicating with entities providing third party translation models 26. As indicated above, LLMs 10 are becoming more and more adept at language translations and, therefore, the ML model selector 32 may include an LLM 10 as a candidate for translating the content of the input 30. The ML model selector 32 and/or the selection model 34 may maintain data such as performance metrics, statistics, outcomes, and historical translation outcomes to determine which of the various models available to the translation engine 22 can and should be used to obtain the perceived “best” translation. As discussed herein, the translation engine 22 may utilize multiple and even many of such translation models 10, 26 to create a ranked candidate list of translations that can be provided as a response to the input 30, in order of preference or some other metric. It can be appreciated that while in FIG. 1, the LLM(s) and model(s) 26 are shows as being separate and remote from the translation engine 22, the translation engine 22 may store and utilize its own set of models in some implementations. Conversely, while the selection model 34 is shown as being part of or local to the translation engine 22 in FIG. 2, in some implementations, the selection model 34 may be provided by some other entity and be accessible to the translation engine 22.

The ML model selector 32 may then provide one or more selected models (and/or an indication of which models to access) to a translation generator 38. The translation generator 38 may include a utility, function or application that is used by the translation engine 22 to generate a translation of one or more portions of content from the input 30. For example, a user may type in a message to be sent to another party in another language, with the text of that message being the content of the input 30 that is translated. The translation generator 38 may be capable of performing the translation itself, e.g., using an obtained model or models, or may coordinate the translation of the content using another entity, e.g., a translation utility that is remote to the translation engine 22. Once generated, the translated content may be provided to the enterprise client application 24 via a UI interface 40. The UI interface 40 may comprise the UI itself or a component of the UI that inserts the output 42 into the workflow of the application 24. As described below, the output 42 may be presented to the user with an option to use, edit or re-try the translation. This may be communicated back to the translation generator 38 via feedback, denoted in FIG. 2 by the character “F”. The feedback F may be initiated by the client application 24 and passed back to the translation generator 38 via the UI interface 40 as shown, or via some other channel (not shown).

The output 42 may therefore be accepted or, via the feedback F, held or discarded before being used as a translated message 44 or other output to the user. The translation generator 38 may therefore be requested to provide a new translation of the original content, using the same or a different model, or provide a translation of edited content using the same model. That is, the feedback F may include an instruction to “re-try” the translation or provide a new input 30 in an attempt to create a better translated version of the content. The translation generator 38 may therefore cooperate dynamically with the ML model selector 32 to select another model with which to obtain another version of the translation. This can be done reactively in response to the feedback F or proactively and asynchronously as the first translation is provided via an output 42. For example, the ML model selector 32 and translation generator 38 may coordinate to have multiple different models used to generate a ranked list and corresponding outputs for the models such that the translation engine 22 is ready to deliver alternative translations without creating additional latency that would otherwise be created by operating reactively.

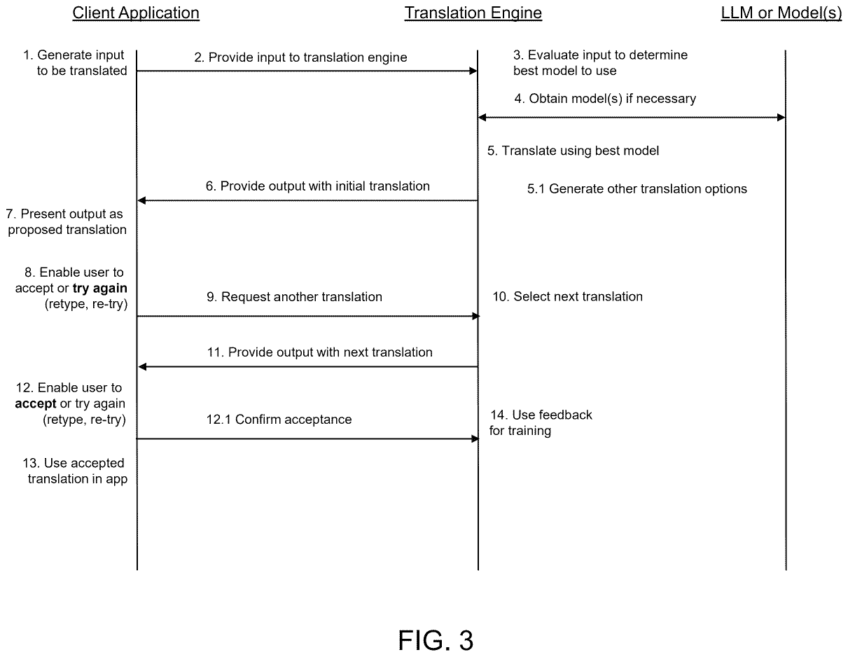

The interactions between the entities of the computing environment 8, e.g., the client application 24 and translation engine 22, as shown in FIG. 2, are illustrated by way of example in the sequence diagram shown in FIG. 3.

At step 1 in FIG. 3, the input 30 to be translated is generated. For example, a user may type text or provide a voice-to-text input to a chat conversation. At step 2, the input 30 is provided to the translation engine 22. At the translation engine 22, the ML model selector 32 may be used at step 3 to evaluate the input 30 to determine the best (or preferred) model to be used. At step 4, the ML model selector 32 may obtain one or more models, if necessary, e.g., if provided by third parties.

At step 5, the translation generator 38 translates the content of the input 30 using its best model (determined at that time). Optionally, at step 5.1, the translation generator 38 may generate other translation options, e.g., asynchronously while steps 6 and onward are performed. At step 6, the output 42 may be provided with an initial translation of the content of the input 30. At step 7, the client application 24 presents the output 42 as the proposed translation, e.g., as a draft message or translation tool result. At step 8, the user can be provided with options to accept or try again. Trying again may include re-typing the content or having the same content translated again (or a combination of both). In this example, as shown in bold, it is assumed that the user has opted to re-try the translation. At step 9, the feedback F may include a re-try request or prompt, which initiates a process to select a next translation at step 10. In this example, assuming that other options have been selected and/or generated at step 5.1, the translation engine 22 may replay immediately with another output 42 that includes the “next” translation to try at step 11. The client application 24 may then enable the user to again view and accept or try again at step 12.

In this example, it is assumed, as shown in bold lettering, that the user accepts this second attempt at the translation. If so, the accepted translation may be used in the client application 24 at step 13, e.g., to adopt the translation, send a message, etc. At the same time, at step 12.1, the client application 24 may generate additional feedback F and send that to the translation engine 22 to confirm acceptance of the second translation attempt. At step 14, the translation engine 22 may use the feedback F in training the selection model 34, for example, which may cause the second translation to be weighted towards certain content, certain user types or other contextual data associated with the current session.

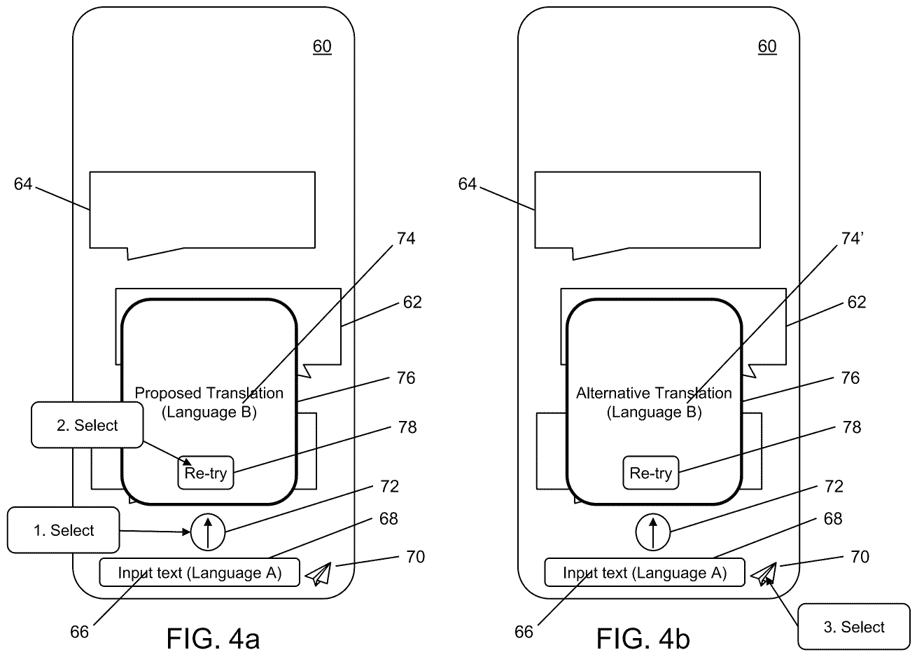

FIGS. 4a and 4b illustrate an example of a UI 60 that may be presented by the client application 24. In this example, the UI 60 comprises a chat conversation with a number of outgoing messages 62 and incoming messages 64. The translation engine 22 may be used by the client application 24 in this example to allow the user to translate content 66 entered into an entry field 68 using a Language A. Prior to selecting a send icon 70, the user may select a translation icon 72 at step 1. This may initiate the process shown in FIGS. 2 and 3, to generate a proposed translation 74 in a Language B. In this example, the UI 60 provides a pop-up 76 that includes the proposed translation 74 and a re-try option 78. It can be appreciated that the UI 60 may allow the user to edit the content 66 or have a different translation model used, as discussed above. By selecting the re-try option 78 at step 2, an alternative translation 74′ may be provided as shown in FIG. 4b. In this example the user may accept the alternative translation 74′ by selecting the send icon 70 at step 3.

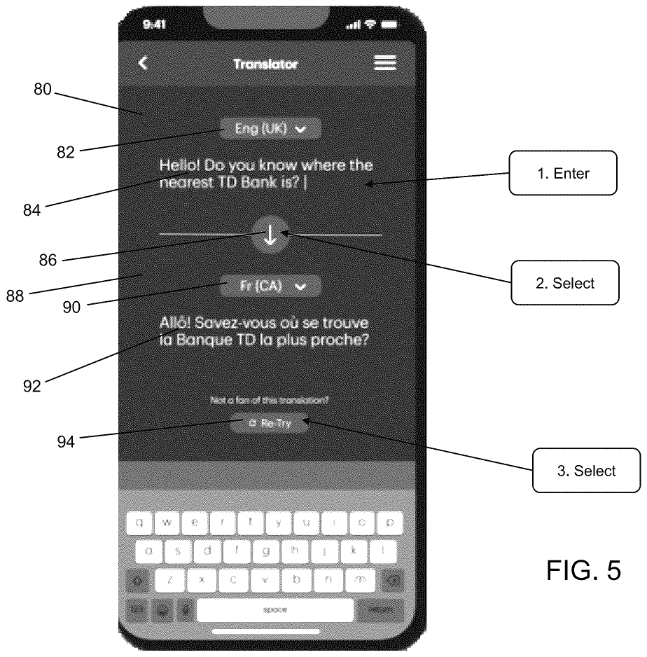

FIG. 5 provides an example of a UI 80 for a stand-alone translation tool provided by or as the client application 24. In this example, the UI 80 provides an input portion 80 with a language selector 82 and an input entry box 84 to generate or provide the content to the translated, e.g., by entering text as shown by way of example at step 1. A translate button 86 may be selected at step 2, to generate a translation 92 in an output portion 88. The output portion 88 may also include a language selector 90. Also provided in the output portion 88 is a re-try button 94 to have the translation re-tried using a different translation model (or edited text) as discussed herein. By selecting the re-try button 94 at step 3, an alternative translation can be generated and presented in the output portion 88.

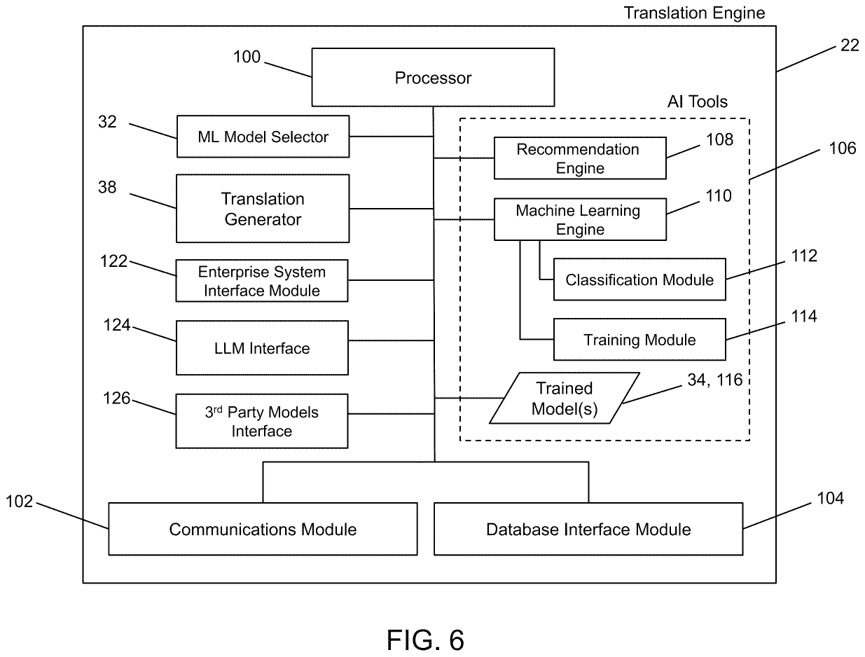

In FIG. 6, an example configuration of the translation engine 22 is shown. In certain embodiments, the translation engine 22 may include one or more processors 100, a communications module 102, and a database interface module 104 for interfacing with the datastores and other data sources, to retrieve, modify, and store (e.g., add) data. Communications module 102 enables the translation engine 22 to communicate with one or more other components of the computing environment 8, such as client device 12, enterprise system 16, LLM(s) 10, third party translation models 26, etc., via a bus or other communication network, such as the communication network 14. While not delineated in FIG. 6, the translation engine 22 includes at least one memory or memory device that can include a tangible and non-transitory computer-readable medium having stored therein computer programs, sets of instructions, code, or data to be executed by processor 100.

FIG. 6 illustrates examples of modules, tools and engines stored in memory on the translation engine 22 and executed by the processor 100. It can be appreciated that any of the modules, tools, and engines shown in FIG. 6 may also be hosted externally and be available to the translation engine 22, e.g., via the communications module 102. In the example embodiment shown in FIG. 6, the translation engine 22 includes a suite or set of AI tools 106. The AI tools 106 may be part of or used by the ML model selector 32 and/or translation generator 38 as needed but are shown separately in FIG. 6 for ease of illustration. The AI tools 106 include or otherwise have access to a recommendation engine 108, a machine learning engine 110, a classification module 112, a training module 114, and at least one trained model 116, which may include the selector model 34. The translation engine 22 may also include an access control module and one or more application programming interfaces (APIs)-not shown, where needed to enable the translation engine 22 to interface with the various components of the computing environment 8, including the enterprise system 16, enterprise server application 20, and third party entities. The translation engine 22 includes the ML model selector 32 and the translation generator 38, as was illustrated in FIG. 2. The translation engine 22 also includes an enterprise system interface module 122 to enable it to communicate with the enterprise system 16 and an LLM interface 124 to enable the translation engine 22 and the AI tools 106 to access the LLM(s) 10 (e.g., third party LLM for generating responses to requests, etc.).

The recommendation engine 108 is used by the AI tools 106 of the translation engine 22 to generate one or more recommendations for the translation engine 22 and/or a client device 12 that is/are related to generating translated content that utilizes the selection model 34. For example, the AI tools 106 may be utilized by the ML model selector 32 to select one or more suitable models to translate content, e.g., using a trained selector model 34. It may be noted that a recommendation as used herein may refer to a prediction, suggestion, inference, association or other recommended identifier that can be used to generate a suggestion, notification, command, instruction or other data that can be viewed, used or consumed by the translation engine 22. The recommendation engine 108 can access data and information and apply one or more inference processes to generate the recommendation(s). The recommendation engine 108 may utilize or otherwise interface with the machine learning engine 110 to both classify data currently being analyzed to generate a suggestion or recommendation, and to train classifiers using data that is continually being processed and accumulated by the translation engine 22. That is, the recommendation engine 108 can learn segmentation outcomes, risk tiers and risk assessments, utilize confusion matrices, etc., and revise and refine classifications, rules or other analytics-related parameters over time. For example, the trained model 116 can be updated and refined using the training module 114 as client devices 12 and/or the translation engine 22 interact with the client app 24 and/or enterprise server application 20, during various interactions to improve the AI/ML parameters and understanding of how certain behaviors relate to, for example, translation parameters including dialects, regionality, etc.

The machine learning engine 110 may also perform operations that classify the segmentation and other data (e.g., client data 18) in accordance with corresponding classifications parameters, e.g., based on an application of one or more machine learning algorithms to the data or groups of the data. The machine learning algorithms may include, but are not limited to, a one-dimensional, convolutional neural network model (e.g., implemented using a corresponding neural network library, such as Keras®), and the one or more machine learning algorithms may be trained against, and adaptively improved, using elements of previously classified profile content identifying suitable matches between content identified and potential actions to be executed. Subsequent to classifying the decision-related content or content being analyzed, the recommendation engine 108 may further process each element of the content to identify, and extract, a value characterizing the corresponding one of the classification parameters, e.g., based on an application of one or more additional machine learning algorithms to each of the elements of the decision-related content. By way of example, the additional machine learning algorithms may include, but are not limited to, an adaptive NLP algorithm that, among other things, predicts starting and ending indices of a candidate parameter value within each element of the content, extracts the candidate parameter value in accordance with the predicted indices, and computes a confidence score for the candidate parameter value that reflects a probability that the candidate parameter value accurately represents the corresponding classification parameter. As described herein, the one or more additional machine learning algorithms may be trained against, and adaptively improved using, the locally maintained elements of previously classified content. The LLM interface 124 may be used to additionally access and prompt the LLM(s) 10 for creating generative content. Classification parameters may be stored and maintained using the classification module 112, and training data may be stored and maintained using the training module 114.

The trained model 116 (including, for example, selection model 34) may also be created, stored, refined, updated, re-trained, and referenced by the translation engine 22 (e.g., by way of the AI tools 106) to determine associations between actions and outcomes associated with behavior, and suitable responses or actions, and/or content related thereto. Such associations can be used to generate recommendations or suggestions for improving decisions being made, e.g., for determining when and how to act on such activity and behaviors to improve the content selection by the translation engine 22.

In some instances, classification data stored in the classification module 112 may identify one or more parameters, e.g., “classification” parameters, that facilitate a classification of corresponding elements or groups of recognized content based on any of the exemplary machine learning algorithms or processes described herein. The one or more classification parameters may correspond to parameters that can indicate an affinity or compatibility between decision parameters and outcomes (e.g., approve or deny), and certain potential actions.

In some instances, the additional, or alternate, machine learning algorithms may include one or more adaptive, NLP algorithms capable of parsing each of the classified portions of the content and predicting a starting and ending index of the candidate parameter value within each of the classified portions. Examples of the adaptive, NLP algorithms include, but are not limited to, NLP models that leverage machine learning processes or artificial neural network processes, such as a named entity recognition model implemented using a SpaCy® library.

Examples of these adaptive, machine learning processes include, but are not limited to, one or more artificial, neural network models, such as a one-dimensional, convolutional neural network model, e.g., implemented using a corresponding neural network library, such as Keras®. In some instances, the one-dimensional, convolutional neural network model may implement one or more classifier functions or processes, such a Softmax® classifier, capable of predicting an association between an element of event data (e.g., a value or type of data being augmented with an event or workflow) and a single classification parameter and additionally, or alternatively, multiple classification parameters.

Based on the output of the one or more machine learning algorithms or processes, such as the one-dimensional, convolutional neural network model described herein, machine learning engine 110 may perform operations that classify each of the discrete elements of decision-related content as a corresponding one of the classification parameters, e.g., as obtained from classification data stored by the classification module 112.

The outputs of the machine learning algorithms or processes may then be used by the recommendation engine 108 to generate one or more suggested recommendations, instructions, commands, notifications, rules, or other instructional or observational elements that can be presented to the AI tools 106. The AI tools 106 may be used by any one or more of the operations shown in FIGS. 2 and 3a-3d described herein. Similarly, the AI tools 106 may use the LLM interface 124 to access third party sources such as GPT-type services that use their own LLMs 10.

In FIG. 7, an example configuration of an enterprise system 16 is shown. The enterprise system 16 includes a communications module 130 that enables the enterprise system 16 to communicate with one or more other components of the computing environment 8, such as an LLM 10 and/or client device(s) 12, via a bus or other communication network, such as the communication network 14. While not delineated in FIG. 7, the enterprise system 16 includes at least one memory or memory device that can include a tangible and non-transitory computer-readable medium having stored therein computer programs, sets of instructions, code, or data to be executed by one or more processors (not shown for clarity of illustration). FIG. 7 illustrates examples of servers and datastores/databases operable within the enterprise system 16. It can be appreciated that any of the components shown in FIG. 7 may also be hosted externally and be available to the enterprise system 16, e.g., via the communications module 130. In the example embodiment shown in FIG. 6, the enterprise system 16 includes one or more servers to provide access to client data 18, e.g., for making decisions related to a particular client or entity (e.g., user of client device 12). Exemplary servers include a mobile application server 132, a web application server 134 and a data server 136. The enterprise system 16 also includes or hosts an LLM 10 and the translation engine 22 in this example. It can be appreciated that, as discussed above, the LLM 10 may be a third party LLM 10 and that more than one LLM 10 may be utilized by the translation engine 22 and/or enterprise system 16.

Although not shown in FIG. 7, as noted above, the enterprise system 16 may also include a cryptographic server for performing cryptographic operations and providing cryptographic services. The cryptographic server can also be configured to communicate and operate with a cryptographic infrastructure. The enterprise system 16 may also include one or more data storage elements for storing and providing data for use in such services, such as data storage for storing client data 18.

Mobile application server 132 supports interactions with a mobile application installed on client device 12. Mobile application server 132 can access other resources of the enterprise system 16 to carry out requests made by, and to provide content and data to, a mobile application on client device. In certain example embodiments, mobile application server 132 supports a mobile banking application to provide payments from one or more accounts of user, among other things.

Web application server 134 supports interactions using a website accessed by a web browser application running on the client device. It can be appreciated that the mobile application server 132 and the web application server 134 can provide different front ends for the same application, that is, the mobile (app) and web (browser) versions of the same application. For example, the enterprise system 16 may provide a banking application that be accessed via a smartphone or tablet app while also being accessible via a browser on any browser-enabled device.

The client data 18 can include, in an example embodiment, financial data that is associated with users of the client devices (e.g., customers of the financial institution). The financial data may include any data related to or derived from financial values or metrics associated with customers of a financial institution system (i.e. the enterprise system 16 in this example), for example, account balances, transaction histories, line of credit available, credit scores, mortgage balances, affordability metrics, investment account balances, investment values and types, among many others. Other metrics can be associated with the financial data, such as financial health data that is indicative of the financial health of the users of the client devices.

It will be appreciated that only certain modules, applications, tools and engines are shown in FIGS. 6 and 7 for ease of illustration and various other components would be provided and utilized by the LLM(s) 10, enterprise system 16, and translation engine 22, as is known in the art.

In FIG. 8, an example configuration of a client device 12 is shown. In certain embodiments, the client device 12 may include one or more processors 150, a communications module 152, and a data store 162 storing device data 164 and application data 166. Communications module 152 enables the client device 12 to communicate with one or more other components of the computing environment 8, such as the enterprise system 16 and/or LLM(s) 10 and/or third party models 26, via a bus or other communication network, such as the communication network 14. While not delineated in FIG. 8, the client device 12 includes at least one memory or memory device that can include a tangible and non-transitory computer-readable medium having stored therein computer programs, sets of instructions, code, or data to be executed by processor 150. FIG. 8 illustrates examples of modules and applications stored in memory on the client device 12 and executed by the processor 150. It can be appreciated that any of the modules and applications shown in FIG. 8 may additionally or alternatively be hosted externally and be available to the client device 12, e.g., via the communications module 152.

In the example embodiment shown in FIG. 8, the client device 12 includes a display module 154 for rendering GUIs and other visual outputs on a display device such as a display screen, and an input module 156 for processing user or other inputs received at the client device 12, e.g., via a touchscreen, input button, transceiver, microphone, keyboard, etc. The client device 12 may also include an LLM module 158, which may take the form of a customized app, plug-in, widget, or software component provided by the LLM(s) 10 for use by the client device 12 to use in communicating with the LLM(s) 10. Similarly, the client device 12 may include the enterprise system client application 24 provided by the enterprise system 16. The client device 12 in this example embodiment also includes a web browser application 160 for accessing Internet-based content, e.g., via a mobile or traditional website. The data store 162 may be used to store device data 164, such as, but not limited to, an IP address or a MAC address that uniquely identifies client device 12 within the computing environment 8. The data store 162 may also be used to store application data 168, such as, but not limited to, login credentials, user preferences, cryptographic data (e.g., cryptographic keys), etc.

It will be appreciated that only certain modules, applications, tools and engines are shown in FIGS. 1-2 and 4-8 for ease of illustration and various other components would be provided and utilized by the LLM(s) 10, third party model(s) 26, client device 12, translation engine 22, and enterprise system 16 as is known in the art.

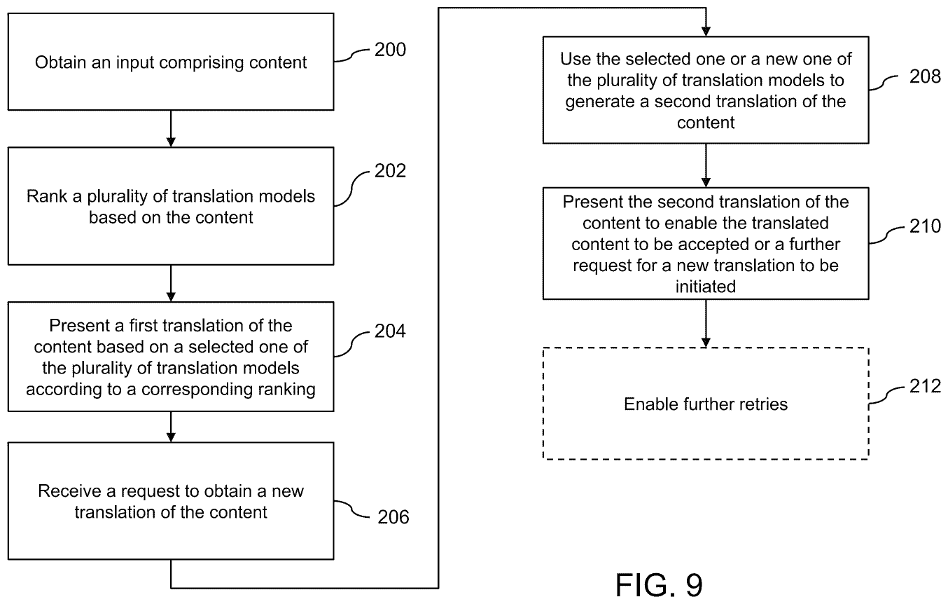

Referring now to FIG. 9, a flow chart illustrates operations that may be performed in generating content translations. At block 200, the translation engine 22 may receive or otherwise obtain an input 30 that includes content. At block 202, the translation engine 22 may utilize the model selector 32 to rank multiple translation models that are available to the translation engine 22 based on the content in the input 30. At block 204, the translation engine 22 may utilize the translation generator 38 to present a first translation of the content based on a selected one of the multiple available translation models and according to the ranking. This may also include generating the translation by the translation engine 22 or having another entity, function, or utility do same. At block 206, the translation engine 22 receives a request to obtain a new translation of the content, e.g., by detecting feedback F.

At block 208, the translation engine 22 may use the selected one or a new one of the multiple translation models to generate a second translation of the content. For example, the translation engine 22 may be asked to re-translate an edited version of the content, which may result in using the same translation model. However, the same content may need to be translated using a different model to present a second translation at block 210. At block 210, the second translation of the content is presented to enable the translated content to be accepter or a further request for a new translation to be initiated. Optionally, at block 212, further retries may be enabled.

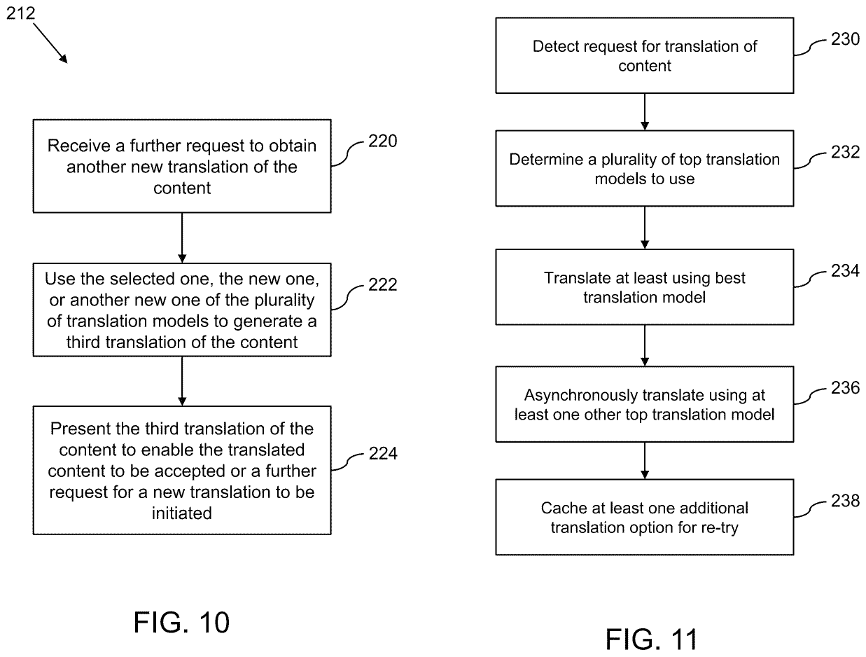

FIG. 10 is a flow chart illustrating example operations that may be performed in enabling selection of a re-try option 78, 94 to present another content translation, e.g., based on optional block 212 in FIG. 9.

At block 220, the translation engine 22 receives a further request to obtain another new translation of the content (i.e., a second re-try). At block 222, the translation engine 22 uses the selected one, the new one, or another new one of the multiple translation models to generate a third translation of the content. That is, depending on whether the content has been edited or otherwise changes, the translation engine 22 may utilize any one of the available translation models, based on the ranking, to provide yet another option for the translation. At block 224, the translation engine 22 may present the third translation of the content (e.g., to the UI 60, 80), to enable the translated content to be accepted or a further request for a new translation (i.e., a third re-try) to be initiated.

FIG. 11 is a flow chart illustrating example operations that may be performed in asynchronously generating multiple translation options and caching same for a re-try option 78, 94. At block 230, the translation engine 22 detects a request for content to be translated. At block 232, the translation engine 22, e.g., using the ML model selector 32, determines multiple top translation models to use, e.g., a number of ranked models that would be deemed acceptable or sufficient based on the content. At block 234, the translation engine 22 may use the translation generator 38 to translate the content using the “best” translation model determined at that time. At block 236, the translation engine 22 may asynchronously translate the content using at least one other of the “top” translation models to enable it to cache or otherwise store at least one additional translation option to be prepared for the user to attempt to re-try the translation at block 238, e.g., as shown by way of example in FIGS. 4 and 5.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of any of the servers or other devices in the computing environment 8, or accessible or connectable thereto. Any application or module herein described may be implemented using computer readable/executable instructions that may be stored or otherwise held by such computer readable media.

It will also be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A computing system for generating content translations, the computing system comprising:
a processor; and
a memory coupled to the processor, the memory storing computer executable instructions that when executed by the processor cause the computing system to:
obtain an input comprising content;
rank a plurality of translation models based on the content;
present a first translation of the content based on a selected one of the plurality of translation models according to a corresponding ranking;
receive a request to obtain a new translation of the content;
use the selected one or a new one of the plurality of translation models to generate a second translation of the content; and
present the second translation of the content to enable the second translation of the content to be accepted or a further request for a new translation to be initiated.

2. The system of claim 1, wherein the request causes the same content to be translated using the new one of the plurality of translation models.

3. The system of claim 1, wherein the request comprises a revised version of the content and causes the revised version of the content to be translated using the selected one of the plurality of translation models.

4. The system of claim 1, wherein the request comprises a revised version of the content and causes the revised version of the content to be translated using the new one of the plurality of translation models.

5. The system of claim 1, wherein the system further comprises instructions to:
after or while the first translation is being generated, translate the content using one or more of the plurality of translation models to prepare at least one re-try option.

6. The system of claim 1, wherein the system further comprises instructions to:
receive a further request to obtain another new translation of the content;
use the selected one, the new one, or another new one of the plurality of translation models to generate a third translation of the content; and
present the third translation of the content to enable the translated content to be accepted or a further request for a new translation to be initiated.

7. The computing system of claim 1, wherein a translation selection model and the content are used to rank the plurality of translation models.

8. The computing system of claim 7, wherein the translation selection model is continuously trained based at least on the request to obtain the new translated content.

9. The computing system of claim 1, wherein at least one of the plurality of translation models comprises a large language model (LLM).

10. The computing system of claim 1, wherein at least one of the plurality of translation models comprises a third party translation model.

11. The computing system of claim 1, wherein the input comprises the content entered in a conversational messaging exchange.

12. The computing system of claim 1, wherein the input comprises the content entered in a translation tool.

13. The computing system of claim 1, wherein the computing system is coupled to a client application on a client device.

14. The computing system of claim 1, wherein the computing system is coupled to a server application on a server device, the server application providing translation functionality for a client application on a client device.

15. A method for generating content translations, the method being implemented by a computing system and comprising:
obtaining an input comprising content;
ranking a plurality of translation models based on the content;
presenting a first translation of the content based on a selected one of the plurality of translation models according to a corresponding ranking;
receiving a request to obtain a new translation of the content;
using the selected one or a new one of the plurality of translation models to generate a second translation of the content; and
presenting the second translation of the content to enable the second translation of the content to be accepted or a further request for a new translation to be initiated.

16. The method of claim 15, wherein the request causes the same content to be translated using the new one of the plurality of translation models.

17. The method of claim 15, wherein the request comprises a revised version of the content and causes the revised version of the content to be translated using the selected one of the plurality of translation models.

18. The method of claim 15, wherein the request comprises a revised version of the content and causes the revised version of the content to be translated using the new one of the plurality of translation models.

19. The method of claim 15, further comprising:
after or while the first translation is being generated, translating the content using one or more of the plurality of translation models to prepare at least one re-try option.

20. A non-transitory computer readable medium storing computer-executable instructions for generating content translations, comprising computer-executable instructions that, when executed by a computing system, cause the computing system to:
obtain an input comprising content;
rank a plurality of translation models based on the content;
present a first translation of the content based on a selected one of the plurality of translation models according to a corresponding ranking;
receive a request to obtain a new translation of the content;
use the selected one or a new one of the plurality of translation models to generate a second translation of the content; and
present the second translation of the content to enable the second translation of the content to be accepted or a further request for a new translation to be initiated.
